(19) United States
(12) Patent Application Publication
(10) Pub. No.: US 2025/0003834 A1
(43) Pub. Date: Jan. 2, 2025

(54) COMPUTER, DIAGNOSIS SYSTEM, AND DIAGNOSIS METHOD

(71) Applicant: Hitachi, Ltd., Tokyo (JP)

(72) Inventor: Hisanori MATSUMOTO, Tokyo (JP)

(21) Appl. No.: 18/589,851

(22) Filed: Feb. 28, 2024

(30) Foreign Application Priority Data
Jun. 27, 2023 (JP) 2023-105156

(51) Int. Cl. G01M 13/045

(52) U.S. Cl. CPC G01M 13/045

(57) ABSTRACT

An order of an autoregressive spectrum is appropriately determined for data having a short data length and a large amount of noise. A computer including one or more processors and one or more memory resources, in which the one or more processors execute a step of acquiring time series data; and a step of determining, as an optimum value of an order of an autoregressive model for the time series data, an integer m−1 in which, in an autoregressive model of an order m−1, a peak of an autoregressive spectrum of the time series data is unimodal, and in an autoregressive model of an order m, a peak of the autoregressive spectrum of the time series data is bimodal.

### BACKGROUND OF THE INVENTION

### 1. Field of the Invention

The present invention relates to a computer, a diagnosis system, and a diagnosis method.

### 2. Description of Related Art

A rotating device such as a turbine, a pump, or a compressor is an important device that supports manufacturing industries, social infrastructure, and the like, and it is important to maintain an operation thereof in a normal state to maintain social activities. Methods of determining whether the rotating device is normal or abnormal include a method of measuring a mechanical vibration of the rotating device and analyzing the mechanical vibration. For example, there is a method of measuring vibration of a housing of the rotating device using an acceleration meter or an acoustic emission (AE) sensor. In this method, measurement data is processed by a numerical value calculation algorithm based on the Fourier transform, and existence of a feature frequency is evaluated by spectrum analysis.

In recent years, the so-called industrial Internet of Things (IoT) has been attracting attention, in which operation and maintenance of industrial devices are remote and automated with the progress of information communication technique and digital technique. In the industrial IoT, for example, various sensors are added to manufacturing facilities, utility facilities, and the like in a factory, sensing data is constantly collected via a wired or wireless network and analyzed to grasp an operation state of each device and an operation state of the entire factory. Vibration diagnosis of the rotating device is considered to be incorporated in a part of IoT in the future.

Since IoT is a system that contiguously transmits and receives various sensor data at all times, a data transmission cost of the entire system is a problem. In order to avoid a shortage of data traffic in an IoT network, it is required that each piece of sensing data has a minimum necessary data length. In the case of the vibration diagnosis of the rotating device, it is desirable to obtain as high a spectral resolution as possible with as short data as possible.

Although fast Fourier transform (FFT) is used as the numerical value calculation algorithm often used for the vibration diagnosis of the rotating device, in the fast Fourier transform, the spectral resolution is reduced as time series data of input becomes shorter.

On the other hand, since a spectrum (autoregressive spectrum) based on an autoregressive model often used for earthquake data or human heartbeat data can obtain high spectral resolution even with short data, the spectrum can be expected to be used for vibration diagnosis for IoT data.

A point to be considered when the numerical value calculation algorithm of the autoregressive spectrum is used is how to determine an order of the autoregressive. The order of autoregressive is a parameter that determines spectral accuracy, and it is known that a “false spectrum” occurs in which the resolution is poor when the order is too small, and spectral peaks are separated when the order is too large. An optimum value of the order largely depends on noise characteristics of the input data, and qualitatively the noisier the data, the larger the order is to be, but in the case of physical data of the vibration diagnosis or the like, an amount of noise in the data is usually not known in advance, and thus the optimum value of the order is also unknown. Therefore, Akaike information criterion (AIC) is used as a method for estimating the optimum value of the order of the autoregressive spectrum in the related art.

### CITATION LIST

### Non Patent Literature

NPL 1: Akaike, H., “Information theory and an extension of the maximum likelihood principle”, Proceedings of the 2nd International Symposium on Information Theory, Petrov, B. N., and Caski, F. (eds.), Akadimiai Kiado, Budapest: 267-281 (1973).

### SUMMARY OF THE INVENTION

However, the optimum value of the order indicated by AIC is very small, about 10% to 20% of a data length of input time series data. Therefore, when the Akaike information criterion is applied to the vibration diagnosis with a short data length, the spectral resolution becomes insufficient and the diagnosis accuracy of the vibration diagnosis decreases.

The invention is made in view of such a situation, and an object of the invention is to appropriately determine the order of the autoregressive spectrum for data having a short data length and a large amount of noise.

In order to solve the above problems, a computer according to an aspect of the invention is a computer including one or more processors and one or more memory resources, in which the one or more processors execute a step of acquiring time series data, and a step of determining, as an optimum value of an order of an autoregressive model for the time series data, an integer m−1 in which, in an autoregressive model of an order m−1, a peak of an autoregressive spectrum of the time series data is unimodal, and in an autoregressive model of an order m, a peak of the autoregressive spectrum of the time series data is bimodal.

According to the invention, the order of the autoregressive spectrum can be appropriately determined for data having a short data length and a large amount of noise.

Problems, configurations, and effects other than those described above will become apparent in the following description of embodiments.

### BRIEF DESCRIPTION OF THE DRAWINGS

FIG. 1 is a configuration diagram of an example of a diagnosis system according to the present embodiment.

FIG. 2 is a schematic diagram showing an example of a bearing and an excitation frequency thereof.

FIG. 3 is a schematic diagram showing an example of time series data measured by an IoT sensor.

FIG. 4 is an example of a flowchart of a process executed by a computer in the present embodiment.

FIG. 5 is an example of a flowchart of number-of-peaks determination processing for determining whether an estimated peak is bimodal.

FIG. 6A is a schematic diagram showing an example of time series data used in simulation.

FIG. 6B is a schematic diagram showing an example of data in which noise is superimposed on the time series data of FIG. 6A.

FIG. 7 is a schematic diagram showing an example of an autoregressive spectrum obtained for various parameters by the simulation.

FIG. 8 is an example of a flowchart of a process executed by a computer in another embodiment.

### DESCRIPTION OF EMBODIMENTS

Hereinafter, an embodiment of the invention will be described with reference to the drawings. In all drawings illustrating the embodiments, the same members are denoted by the same reference numerals in principle, and repeated descriptions thereof will be appropriately omitted. In the following embodiments, it is needless to mention that components (also including element steps and the like) thereof are not necessarily essential unless otherwise specified or unless clearly considered to be essential in principle. In addition, in the case of “formed by A”, “configured of A”, “having A”, and “including A”, it is needless to say that other elements are not excluded, except for a case where it is clearly indicated that only the element is included. Similarly, in the following embodiments, when a shape, a positional relation, or the like of a component or the like is referred to, the shape or the like is substantially approximate or similar to the shape or the like unless otherwise specified or principally apparent that it is not.

### Present Embodiment

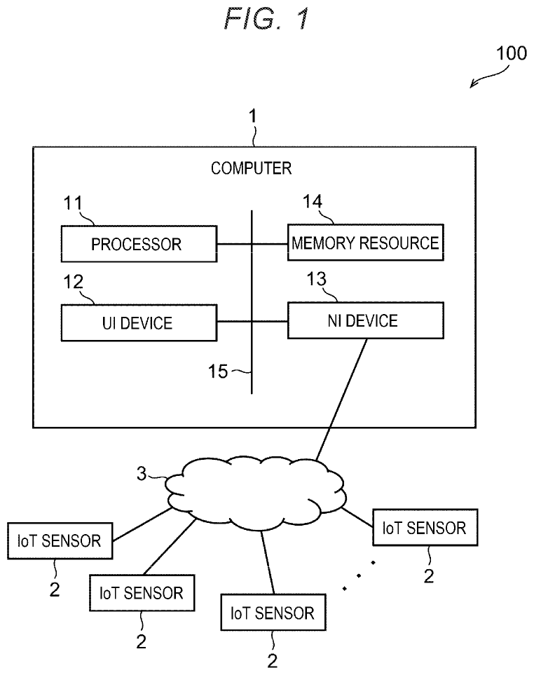

FIG. 1 is a configuration diagram of an example of a diagnosis system according to the present embodiment. The diagnosis system 100 is a system that diagnoses whether there is an abnormality in a diagnosis target that periodically vibrates, such as a turbine, a pump, and a compressor, and includes a computer 1 and an IoT sensor 2.

In order to perform data generation, transmission, reception, and various other processes, the computer 1 causes a processor to read a diagnosis program stored in a memory resource, and the processor executes processing according to the diagnosis program. The computer 1 is, for example, a personal computer, a tablet terminal (computer), a smartphone, a server computer, a blade server, and a cloud server, and is a system including at least one or more of these computers. That is, the computer 1 also includes a system including, for example, a cloud server and a display computer (for example, a tablet terminal or a smartphone). Further, a controller that controls or manages some device including a processor and a memory resource is also an example of the computer 1.

Specifically, as shown in FIG. 1, the computer 1 includes one or more processors 11, one or more user interface (UI) devices 12, one or more network interface (NI) devices 13, and one or more memory resources 14. The computer 1 may include other components. The processor 11, the UI device 12, the NI device 13, and the memory resource 14 are connected with one another via a bus 15.

The processor 11 is a calculation device that reads various programs stored in the memory resource 14 and executes processing corresponding to each program. Examples of the processor 11 include a microprocessor, a central processing unit (CPU), a graphics processing unit (GPU), a field programmable gate array (FPGA), a quantum processor, and other semiconductor devices that can perform calculation.

The UI device 12 is an input device that inputs an instruction of a user (may be an operator) to the computer 1, and an output device that outputs information generated by the computer 1. Examples of the input device include pointing devices such as a keyboard, a touch panel, and a mouse, and voice input devices such as a microphone. Examples of the output device include a display, a printer, and a speech synthesizer. Unless otherwise mentioned below, input and output of information between the computer 1 and the user are performed via the UI device 12. The UI device 12 may be only an input device or only an output device.

The NI device 13 is a communication device that performs information communication with an external device such as the IoT sensor 2. The NI device 13 performs the information communication with the IoT sensor 2 via a predetermined network 3 such as the Internet or a local area network (LAN). Unless otherwise mentioned below, the information communication between the computer 1 (or the processor 11) and the IoT sensor 2 is executed via the NI device 13.

The memory resource 14 is a storage device that stores a diagnosis program and the like according to the present embodiment, and is, for example, a nonvolatile memory or/and a volatile memory. Examples of the volatile memory include a random access memory (RAM) and a read only memory (ROM). Examples of the nonvolatile memory may include a rewritable storage medium such as a flash memory, a hard disk, or a solid state drive (SSD), and may be a universal serial bus (USB) memory, a memory card, or a hard disk. Further, a RAM called a magnetoresistive RAM (MRAM), a phase change RAM (PRAM), or a resistive RAM (ReRAM) may be regarded as the nonvolatile memory. The processor 11 may perform a service of distributing the diagnosis program stored in the memory resource 14 to another computer.

The IoT sensor 2 is a vibration sensor that measures periodic vibration occurring in a diagnosis target and outputs vibration data indicating a temporal change in a measurement result. As an example, the vibration sensor is an acceleration sensor that measures an acceleration generated by the vibration. The diagnosis target is a rotating device such as a motor including a rotating mechanism. The rotating device is provided with a bearing that rotatably supports a rotation shaft. It is known that the bearing vibrates at different excitation frequencies fₑ depending on a damaged portion.

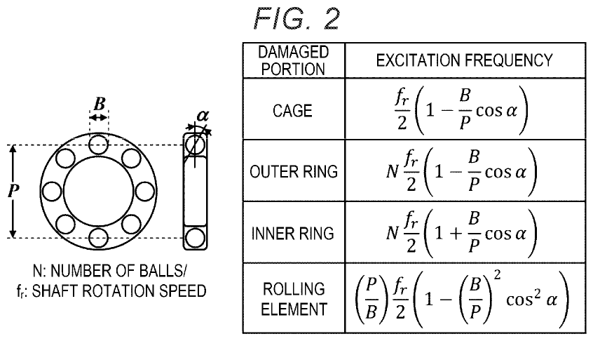

FIG. 2 is a schematic diagram showing an example of the bearing and the excitation frequency fₑ thereof. As shown in FIG. 2, the bearing includes respective components of a cage, an outer ring, an inner ring, and a rolling element, and the excitation frequency fₑ is given by four equations different for each component. In each equation, fᵣ is a shaft rotation speed, N is the number of balls of the rolling element, α is a contact angle between the rolling element and the outer ring, P is a pitch diameter, and B is a ball diameter of the rolling element.

The processor 11 determines whether any one of the four excitation frequencies fₑ is included in a spectrum of the vibration data measured by the IoT sensor 2. When determining that any one of the four excitation frequencies fₑ is included in the spectrum of the vibration data, the processor 11 determines that damage occurs in a component corresponding to the excitation frequency fₑ.

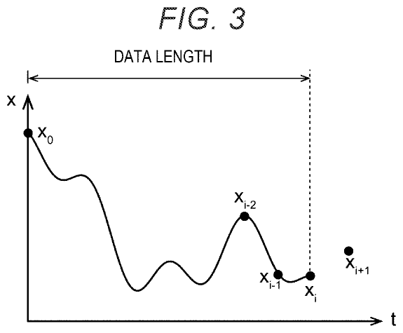

FIG. 3 is a schematic diagram showing an example of time series data X measured by the IoT sensor 2. The time series data X is the vibration data indicating the temporal change in the vibration of the diagnosis target including the bearing and the like. Thereby, when a peak corresponding to the excitation frequency fₑ occurs in an autoregressive spectrum of the time series data X, the processor 11 can determine that damage occurs in the component corresponding to each excitation frequency fₑ.

The time series data X is not limited to the vibration data, and any data having temporal or spatial periodicity may be used as the time series data X. When such time series data X is spectrally decomposed in a frequency space, a feature frequency that appears periodically appears. The excitation frequency fₑ described above is an example of the feature frequency.

In the present embodiment, the processor 11 calculates the autoregressive spectrum of the time series data X by an autoregressive model. The autoregressive model is a model that estimates, when the time series data X including x₀, x₁, . . . , and xᵢ is given, a value of the (i+1)-th data xᵢ₊₁ from the following Equation (1).

$${x}_{i + 1} = {\sum }_{k = 0}^{m} {a}_{k} {x}_{i - k} + {e}_{i + 1} \qquad ( 1 )$$

In Equation (1), eᵢ₊₁ is white noise, and aₖ (k=0, . . . m) is a coefficient of the model. The processor 11 uses a predetermined algorithm to obtain the coefficient aₖ (k=0, . . . , m) for obtaining the data xᵢ₊₁ from the known data x₀, x₁, . . . , and xᵢ. This m is referred to as an order of the autoregressive model.

When the coefficient aₖ (k=0, . . . , m) of the autoregressive model having the order of m is obtained, the processor 11 calculates a spectrum Pₘ(f) of the time series data X based on the following Equation (2).

$${P}_{m} ( f ) = \frac{{σ}_{m}^{2}}{\vert 1 - {\sum }_{k = 0}^{m} {a}_{k} {e}^{- j 2 π fk Δ t} \vert} \qquad ( 2 )$$

In Equation (2), Δt is a time interval between adjacent data xⱼ and xⱼ₊₁. In addition, σ²ₘ is a variance of the white noise eᵢ₊₁.

The processor 11 determines whether any one of the plurality of excitation frequencies fₑ in FIG. 2 appears in the spectrum Pₘ(f), and determines that the damage occurs in the component corresponding to the excitation frequency fₑ when the excitation frequency fₑ appears in the spectrum Pₘ(f).

A resolution of the spectrum Pₘ(f) depends on the order m, and when the order m is too small, the resolution decreases. Although the resolution can be improved by increasing the order m, the number (data length) of data xₖ (k=0, . . . , m) required for Equation (1) increases. When the data length becomes long, a traffic on the network 3 becomes congested due to the time series data X transmitted from the plurality of IoT sensors 2. Furthermore, when the order m is large, there is a problem that a “false spectrum” occurs in which a peak corresponding to the excitation frequency fₑ is separated into two peaks.

Therefore, in the present embodiment, when the order m is increased from an initial value m₀ thereof, the processor 11 calculates the order immediately before the “false spectrum” occurs, and determines the order as an optimal order.

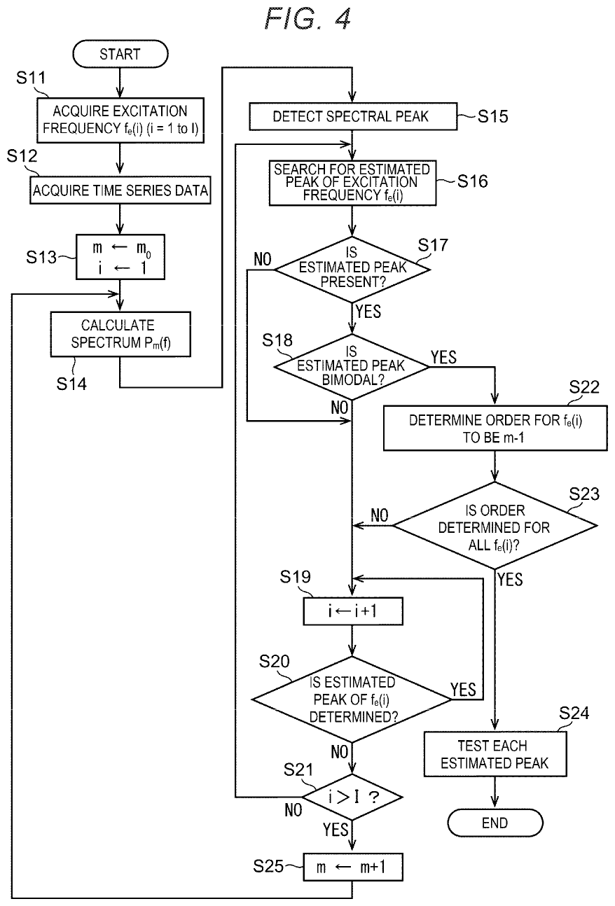

FIG. 4 is an example of a flowchart of a process executed by the computer 1 in the present embodiment.

In the following, the number of components that may be damaged per one diagnosis target is I, and a diagnosis frequency corresponding to each component is expressed as an excitation frequency fₑ(i). When the number of the components that may be damaged is one, I=1 may be set in the following description.

First, the processor 11 acquires the excitation frequency fₑ(i) (i=1, . . . , I) of the diagnosis target (step S11). Each excitation frequency fₑ(i) is known, and for example, the processor 11 acquires the excitation frequency fₑ(i) input by the user from the UI device 12 and stores the excitation frequency fₑ(i) in the memory resource 14. As shown in FIG. 2, each excitation frequency fₑ(i) has a different value for each damaged component.

Next, the processor 11 acquires the time series data X (step S12). As an example, the processor 11 acquires diagnosis data measured by one of the plurality of IoT sensors 2 via the network 3 as the time series data X and stores the diagnosis data in the memory resource 14.

Next, the processor 11 assigns the initial value m₀ to the order m, and assigns the number I to a variable i (step S13). Although the initial value m₀ is not particularly limited, for example, it takes time to find the optimal order m when the initial value m₀ is a small integer such as 1. Therefore, it is preferable that a value greater than 1 input by the user from the UI device 12 is set as the initial value m₀.

Next, the processor 11 calculates the autoregressive spectrum Pₘ(f) of the order m of the time series data X based on Equations (1) and (2) described above (step S14).

Subsequently, the processor 11 detects a spectral peak included in the autoregressive spectrum Pₘ(f) (step S15).

Next, the processor 11 searches for an estimated peak estimated to be a peak corresponding to the excitation frequency fₑ(i) from the detected spectral peak (step S16).

Subsequently, the processor 11 determines whether the estimated peak is present (step S17). Here, when it is determined that the estimated peak is present (YES), the process proceeds to step S18.

In step S18, the processor 11 determines whether the estimated peak is bimodal. Here, when it is determined that the estimated peak is unimodal and not bimodal (NO), the process proceeds to step S19. When it is determined as NO in step S17 described above, the process also proceeds to step S19.

In step S19, the processor 11 increments the variable i by 1.

Next, the processor 11 determines whether the estimated peak corresponding to the excitation frequency fₑ(i) is determined (step S20). When it is determined that the excitation frequency fₑ(i) is determined (YES), the process returns to step S19.

In contrast, when it is determined as NO in step S20, the process proceeds to step S21. In step S21, the processor 11 determines whether the value of the variable i is greater than the number I. When it is determined as large (YES), the process proceeds to step S25, the processor 11 increments the order m by 1, and the process returns to step S14. In contrast, when it is determined as NO in step S21, the process returns to step S16.

When it is determined as YES is step S18, the process proceeds to step S22. In step S22, the processor 11 determines the order m of the autoregressive model with respect to the excitation frequency fₑ(i) as an immediately preceding order m−1 at which the estimated peak is determined as bimodal in step S18. In this case, at the order m−1, the estimated peak is unimodal, and at the order m, the estimated peak is bimodal.

Next, the processor 11 determines whether the order is determined for all I excitation frequencies fₑ(i) (step S23). When it is determined that the order is not determined for all I excitation frequencies fₑ(i) (NO), the process proceeds to step S19 described above.

In contrast, when it is determined as YES in step S23, the process proceeds to step S24. In step S24, the processor 11 tests each of the I estimated peaks. As an example, the processor 11 determines whether a difference between a frequency of each estimated peak and the excitation frequency fₑ(i) corresponding to the estimated peak falls within an acceptable range, thereby testing whether the estimated peak actually corresponds to the excitation frequency fₑ(i).

Thus, the basic process executed by the computer 1 in the present embodiment is completed.

In this example, in step S18, the processor 11 determines whether the estimated peak is bimodal. An example of the determination processing will be described below.

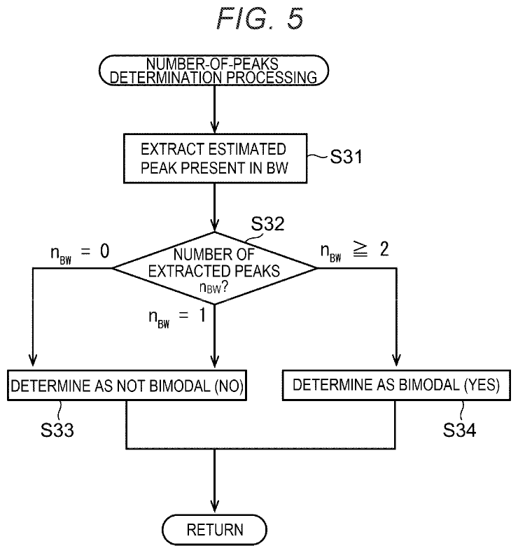

FIG. 5 is an example of a flowchart of number-of-peaks determination processing for determining whether the estimated peak is bimodal.

First, the processor 11 extracts an estimated peak included in a predetermined bandwidth BW (step S31). The predetermined bandwidth BW is predetermined each excitation frequency fₑ(i), and is, for example, a bandwidth centered on the excitation frequency fₑ(i).

In this example, the user sets the predetermined bandwidth BW for each excitation frequency fₑ(i) so as not to overlap one another. Accordingly, in the predetermined bandwidth BW corresponding to a certain excitation frequency fₑ(i), an estimated peak corresponding to another excitation frequency fₑ (j) (j≠i) does not appear, and the processor 11 can be prevented from erroneously recognizing the estimated peak as the estimated peak of the excitation frequency fₑ(i). A value of about 60% to 80% of the excitation frequency fₑ(i) may be set as a width of the predetermined bandwidth BW.

Next, the processor 11 determines the number new of the extracted peaks (step S32). Here, when it is determined that “n_{BW}=0” or “n_{BW}=1”, the processing proceeds to step S33, and the processor 11 determines that the estimated peak is not bimodal.

In contrast, when it is determined that “n_{BW}≥2” in step S32, the processing proceeds to step S34, and the processor 11 determines that the estimated peak is bimodal.

Thus, basic processing in the number-of-peaks determination processing is completed.

According to the present embodiment described above, the integer m−1 in which the peak of the autoregressive spectrum of the time series data X in the autoregressive model of the order m−1 is unimodal and the peak is bimodal in the order m is determined as the optimum value of the order of the autoregressive model for the time series data X. The order m−1 is the maximum integer at which the peak of the autoregressive spectrum is not the false spectrum but unimodal. Accordingly, by determining the order m−1 as the order of the autoregressive model, it is possible to improve the spectral resolution of the autoregressive model by a large order while preventing the false spectrum. In particular, the time series data X output by the IoT sensor 2 tends to have a short data length and a large amount of noise. For such data X, the order of the autoregressive spectrum can be appropriately determined in the present embodiment.

In the example of FIG. 4, in step S22, the optimal order m−1 is determined for each of the plurality of excitation frequencies fₑ(i) (i=1, . . . , I). Therefore, when the excitation frequency is different for each damaged portion to be diagnosed as shown in FIG. 2, the optimal order m−1 can be determined for each damaged portion.

Next, a simulation result of the present embodiment will be described.

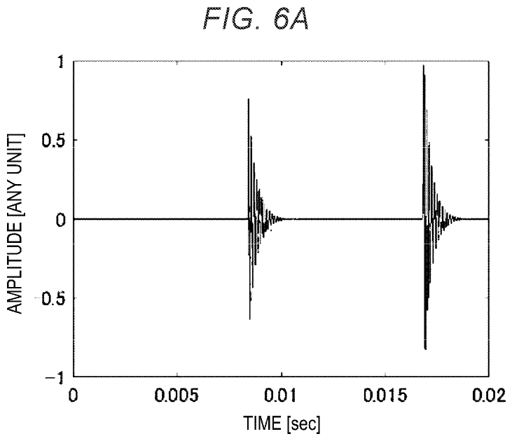

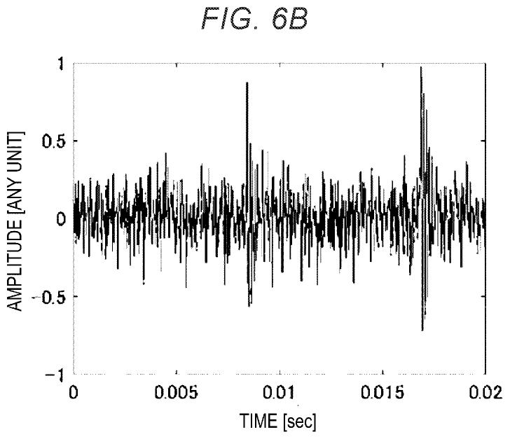

FIG. 6A is a schematic diagram showing an example of the time series data X used in simulation. As shown in FIG. 6A, the time series data X has a peak corresponding to a period of vibration. The data length of the time series data is 20 msec. The time series data X of this data length has 977 data xᵢ.

FIG. 6B is a schematic diagram showing an example of data in which a noise is superimposed on the time series data X of FIG. 6A. By using the data, the optimal order of the autoregressive model is obtained by the simulation according to the present embodiment.

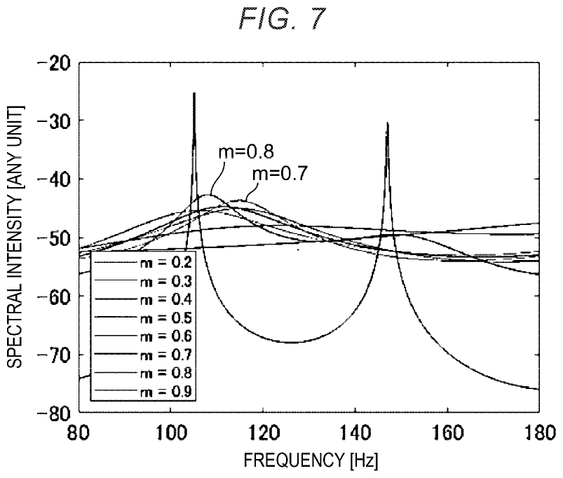

FIG. 7 is a schematic diagram showing an example of the autoregressive spectrum obtained for various parameters m by the simulation. The parameter m is the number of orders of the autoregressive model by multiplying the number of data (=977) included in the time series data X. For example, when m=0.7, the order of the autoregressive model is 684.

In this simulation, an optimum value of the order of the autoregressive model is 743. This value corresponds to about 76% of the number of data (=977) included in an original data length. The order is 205 in a method of the related art using the AIC, and it is confirmed that the order can be made larger in the present embodiment than in the method of the related art. In addition, in this simulation, it is confirmed that the frequency of the estimated peak is 115.18 Hz, and an error from a theoretical value (118.875 Hz) of the excitation frequency is as good as 3.1%.

### Other Embodiments

In the present embodiment, a process when a noise is included in the time series data will be described.

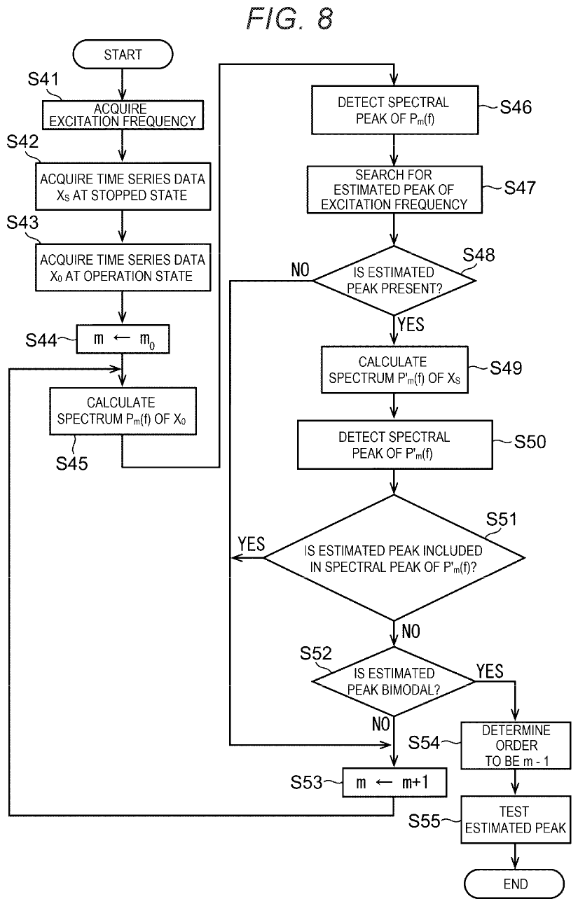

FIG. 8 is an example of a flowchart of a process executed by the computer 1 in the present embodiment. In the following description, to simplify the description, it is assumed that the number of components that may be damaged per diagnosis target is one, and one excitation frequency caused by damage to the component is fₑ.

First, the processor 11 acquires the excitation frequency fₑ(i) of the diagnosis target (step S41).

Next, the processor 11 acquires time series data Xₛ in a state in which the diagnosis target is stopped (step S42). For example, the processor 11 acquires diagnosis data measured by the IoT sensor 2 provided in the diagnosis target such as a motor in the stopped state via the network 3 as the time series data Xₛ, and stores the time series data Xₛ in the memory resource 14. The time series data Xₛ is an example of first vibration data.

Next, the processor 11 acquires time series data X₀ in a state in which the diagnosis target is operating (step S43). As an example, the processor 11 acquires diagnosis data measured by the IoT sensor 2 provided in a rotating motor or the like as the time series data X₀ via the network 3, and stores the diagnosis data in the memory resource 14. The time series data X₀ is an example of second vibration data.

Next, the processor 11 assigns the initial value m₀ to the order m (step S44). For example, the processor 11 assigns the value greater than 1 input by the user from the UI device 12 to the order m as the initial value m₀.

Next, the processor 11 calculates the autoregressive spectrum Pₘ(f) of the order m of the time series data X₀ based on Equations (1) and (2) described above (step S45).

Subsequently, the processor 11 detects the spectral peak included in the autoregressive spectrum Pₘ(f) (step S46).

Next, the processor 11 searches for an estimated peak estimated to be a peak corresponding to the excitation frequency fₑ from the detected spectral peak (step S47). The estimated peak is an example of a first peak.

Subsequently, the processor 11 determines whether the estimated peak is present (step S48). Here, when it is determined that the estimated peak is present (YES), the process proceeds to step S49.

In step S49, the processor 11 calculates an autoregressive spectrum P′ₘ(f) of the order m of the time series data Xₛ based on Equations (1) and (2) described above.

Subsequently, the processor 11 detects the spectral peak included in the autoregressive spectrum P′ₘ(f) (step S50). The spectral peak is an example of a second peak.

Next, the processor 11 determines whether the estimated peak searched for in step S47 is included in the spectral peak of the autoregressive spectrum P′ₘ(f) (step S51). In contrast, when it is determined that the estimated peak is not included in the spectral peak (NO), the process proceeds to step S52.

In step S52, the processor 11 determines whether the estimated peak is bimodal. When it is determined that the estimated peak is not bimodal (NO), the process proceeds to step S53, and the processor 11 increments the order m by 1. When it is determined as NO in step S48 and when it is determined as YES in step S51, step S53 is executed. Thereafter, the process returns to step S45.

In contrast, when it is determined as YES in step S52, the process proceeds to step S54. In step S54, the processor 11 determines the order m of the autoregressive model with respect to the excitation frequency fₑ as an immediately preceding order m−1 at which the estimated peak is determined as bimodal in step S52.

Next, the processor 11 determines whether a difference between a frequency of the estimated peak and the excitation frequency fₑ falls within an acceptable range, thereby testing whether the estimated peak actually corresponds to the excitation frequency fₑ (step S55).

Thus, the basic process executed by the computer 1 in the present embodiment is completed.

According to the present embodiment described above, when the estimated peak searched for in step S47 is not included in the spectral peak of the autoregressive spectrum P′ₘ(f) (step S51: NO), the order of the autoregressive model is determined to be m−1 (step S54). In this way, when the estimated peak is not included in the spectral peak of the autoregressive spectrum P′ₘ(f), the estimated peak does not appear while the diagnosis target is stopped. Therefore, the estimated peak is not a noise that occurs while the diagnosis target is stopped but is a peak that occurs when the diagnosis target is driven. Therefore, in the present embodiment, it is possible to prevent the noise that occurs while the diagnosis target is stopped from being mistaken as estimated noise.

The effects described in the specification are merely examples, and other effects may be provided.

The invention is not limited to the above-described embodiments and includes various modifications. For example, the embodiments described above have been described in detail for easy understanding of the invention, and the invention is not necessarily limited to those including all the configurations described above. A part of a configuration according to one embodiment can be replaced with a configuration according to another embodiment, and a configuration according to another embodiment can be added to a configuration according to one embodiment. In addition, another configuration can be added to, deleted from, or replaced with a part of a configuration of each embodiment.

A part or all of configurations, functions, processing units, processing methods, and the like described above may be implemented by hardware by, for example, designing with an integrated circuit. In addition, the configurations, functions, and the like described above may be implemented by software by a processor interpreting and executing a program for implementing each function. Information such as a program, a determination table, and a file for realizing each function may be stored in a memory, a storage device such as an HDD or an SSD, or a recording medium such as an integrated circuit (IC) card, a secure digital (SD) card, or a digital versatile disc (DVD). Control lines and information lines indicate what is considered to be necessary for explanation, and not necessarily all control lines and information lines are always shown on a product. Actually, almost all configurations may be considered to be connected to one another.

The computer 1 may be implemented by a user (operator) performing a part or all of functions and processes implemented by the diagnosis program.

In some cases, the computer 1 does not have the UI device 12 and instead entrusts a part of output processing to the user and input processing from the user to a processor system (referred to as an external processor system) such as a smartphone or tablet terminal outside the system. In such a case, the computer 1 (or the processor 11 and the diagnosis program) may perform the following processes in order to execute the processes described above or other portions of the program.
In place of the output to the user using the UI device 12 described above, data necessary for output to the user is transmitted to the external processor system via the NI device 13. As an example of the data, data to be output and data for generating output data in another processor system may be considered, and a program or Web data describing a process of outputting to the user by the external processor system may be used.
In place of the input or the operation reception from the user using the UI device 12 described above, data indicating a user input or an operation is received from the external processor system via the NI device 13. From another viewpoint, the meaning of the data output to the user includes that the computer 1 per se outputs the data to the user, and may include causing another presence other than the computer 1 to output the data (causative). The meaning of the input or the operation reception from the user may include indirect reception by the computer 1 in addition to direct output or reception to the user by the UI device 12 of the computer 1.

What is claimed is:

1. A computer including one or more processors and one or more memory resources, wherein
the one or more processors are configured to execute
a step of acquiring time series data, and
a step of determining, as an optimum value of an order of an autoregressive model for the time series data, an integer m−1 in which, in an autoregressive model of an order m−1, a peak of an autoregressive spectrum of the time series data is unimodal, and in an autoregressive model of an order m, a peak of the autoregressive spectrum of the time series data is bimodal.

2. The computer according to claim 1, wherein
the time series data includes a plurality of feature frequencies corresponding to the unimodal peak, and
the one or more processors are configured to execute the step of determining the integer m−1 as the optimum value of the order for each of the feature frequencies.

3. The computer according to claim 2, wherein
the one or more processors are configured to determine, in the step of determining the integer m−1 as the optimum value of the order, whether the peak is unimodal or bimodal in a predetermined bandwidth predetermined for each of the feature frequencies.

4. The computer according to claim 3, wherein
predetermined bandwidths for the feature frequencies do not overlap with each other.

5. The computer according to claim 1, wherein
the time series data is vibration data indicating a temporal change in vibration of a diagnosis target.

6. The computer according to claim 5, wherein
the computer is configured to
acquire, in the step of acquiring the time series data, first vibration data as the time series data when the diagnosis target is in a stopped state and second vibration data as the time series data when the diagnosis target is in an operation state,
execute a step of detecting a first peak which is a peak of an autoregressive spectrum of the first vibration data in the autoregressive model of the order m,
execute a step of detecting a second peak which is a peak of an autoregressive spectrum of the second vibration data in the autoregressive model of the order m, and
determine the integer m−1 as the optimum value of the order of the autoregressive model for the time series data when the second peak is not included in the first peak.

7. A diagnosis system including a sensor and a computer, wherein
the computer is configured to execute
a step of acquiring time series data indicating a temporal change in a measurement result of the sensor; and
a step of determining, as an optimum value of an order of an autoregressive model for the time series data, an integer m−1 in which, in an autoregressive model of an order m−1, a peak of an autoregressive spectrum of the time series data is unimodal, and in an autoregressive model of an order m, a peak of the autoregressive spectrum of the time series data is bimodal.

8. The diagnosis system according to claim 7, wherein
the time series data includes a plurality of feature frequencies corresponding to the unimodal peak, and
the computer is configured to execute the step of determining the integer m−1 as the optimum value of the order for each of the feature frequencies.

9. The diagnosis system according to claim 8, wherein
the computer is configured to determine, in the step of determining the integer m−1 as the optimum value of the order, whether the peak is unimodal or bimodal in a predetermined bandwidth predetermined for each of the feature frequencies.

10. The diagnosis system according to claim 9, wherein
predetermined bandwidths for the feature frequencies do not overlap with each other.

11. The diagnosis system according to claim 7, wherein
the sensor is a vibration sensor configured to measure vibration of a diagnosis target, and
the time series data is vibration data indicating a temporal change in the vibration.

12. The diagnosis system according to claim 11, wherein
the computer is configured to
acquire, in the step of acquiring the time series data, first vibration data as the time series data when the diagnosis target is in a stopped state and second vibration data as the time series data when the diagnosis target is in an operation state,
execute a step of detecting a first peak which is a peak of an autoregressive spectrum of the first vibration data in the autoregressive model of the order m,
execute a step of detecting a second peak which is a peak of an autoregressive spectrum of the second vibration data in the autoregressive model of the order m, and
determine the integer m−1 as the optimum value of the order of the autoregressive model for the time series data when the second peak is not included in the first peak.

13. A diagnosis method executed by a computer including one or more processors and one or more memory resources, the diagnosis method comprising:
a step of acquiring time series data; and
a step of determining, as an optimum value of an order of an autoregressive model for the time series data, an integer m−1 in which, in an autoregressive model of an order m−1, a peak of an autoregressive spectrum of the time series data is unimodal, and in an autoregressive model of an order m, a peak of the autoregressive spectrum of the time series data is bimodal.

14. The diagnosis method according to claim 13, wherein
the time series data includes a plurality of feature frequencies corresponding to the unimodal peak, and
the step of determining the integer m−1 as the optimum value of the order is executed for each of the feature frequencies.

15. The diagnosis method according to claim 14, further comprising:
determining, in the step of determining the integer m−1 as the optimum value of the order, whether the peak is unimodal or bimodal in a predetermined bandwidth predetermined for each of the feature frequencies.
